(19) United States
(12) Patent Application Publication
(10) Pub. No.: US 2008/0126257 A1
(43) Pub. Date: May 29, 2008

(54) Capacity ordering from storage apparatus

(76) Inventors: Curtis C. Ballard, Eaton, CO (US); Kelly J. Reasoner, Fort Collins, CO (US); Mike P. Fleischmann, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/259,218

(22) Filed: Oct. 26, 2005

(51) Int. Cl. G06F 19/00; H04L 9/00

(52) U.S. Cl. 705/59; 700/214

(57) ABSTRACT

Storage apparatus and related methods for managing removable media. A controller is coupled to an operator control panel and is in communication with an user interface. The controller is configured to robotically manage the removable media and to monitor a licensed storage capacity of the storage apparatus, and can communicate with an authorization source. When the storage capacity reaches a predetermined level of the licensed storage capacity, the user interface displays a prompt to acquire additional licensed storage capacity.

### BACKGROUND

Businesses, governmental agencies, learning institutions, and other organizations typically operate computers that are interconnected by a network. Network users often store data on hard drives of network servers. Users also store data on their host computers.

Data stored on the network and/or host computers is typically backed-up periodically to create a copy of the data to prevent it from being lost due to mechanical failure or accidental deletion, for example, and/or to produce an archive of the data. Backup operations typically involve storing a copy of all or a portion of the data files on the network and/or host computers to a backup device such as a magnetic tape library having a plurality of magnetic tape drives.

Digital magnetic tape has long been used for data storage in computer systems. The low cost-per-bit stored, long-term retention capability, and portability of magnetic tape cartridges have made them invaluable for storing large quantities of data generated by businesses.

Tape cartridges are used by automated tape library devices. Tape libraries generally handle many tape cartridges to store very large amounts of data. The tape libraries hold the tape cartridges in predefined positions or media slots. When data is required from a particular tape cartridge, a host system communicates via a Small Computer System Interface (SCSI) bus or a Fibre Channel (FC) fabric, for example, with a controller of the tape library. The controller retrieves the particular tape cartridge from its media slot and places the tape cartridge in a tape drive. The host system may then read from or write to the tape cartridge via the tape drive. Also, the host system may query the controller to determine the number of tape cartridges, tape drives, and robotics mechanisms contained in the tape library to manage the tape library.

There are a number of manufacturers of tape libraries that back up and store large quantities of data to digital magnetic tape cartridges. For example, a StorageWorks brand of tape libraries are manufactured in various sizes and configurations. The number of tape cartridges that can be loaded into such tape libraries varies depending upon model, but may be on the order of 400-500 tapes, for example.

A typical tape library usually has a control and display panel (or operator control panel) where local functions are controlled and where the health of the tape library may be displayed. The display typically presents information about components in the tape library that are built by the original library manufacturer. Value added components may also be installed in the tape library including software tools to aid in the configuration, installation, and management of the tape library.

Heretofore, it has not been possible to easily increase or activate additional capacity or purchase licenses to use the additional capacity when it is needed. Calling a supplier to increase capacity is generally time consuming, and is fraught with potential errors, including providing a wrong serial number or enter a wrong activation key, for example.

### BRIEF DESCRIPTION OF THE DRAWINGS

The various features and advantages of embodiments of the present invention may be more readily understood with reference to the following detailed description taken in conjunction with the accompanying drawings, wherein like reference numerals designate like structural elements, and in which:

FIG. 1 is a block diagram that illustrates an exemplary tape library;

FIG. 2 illustrates exemplary on-demand ordering of tape capacity increases;

FIGS. 3a-3e illustrate exemplary display screens that implement on-demand ordering of tape capacity increases from a backup storage device; and

FIG. 4 is a flow diagram that illustrates an exemplary method or algorithm for use with backup storage devices.

### DETAILED DESCRIPTION

Backup storage apparatus 10 is disclosed and is discussed below in the context of a magnetic tape library 10. However, it is to be understood that the backup storage apparatus 10 is not limited only to magnetic tape libraries, but may be employed in the context of other storage devices and systems, including optical drives and hard disk drives, for example.

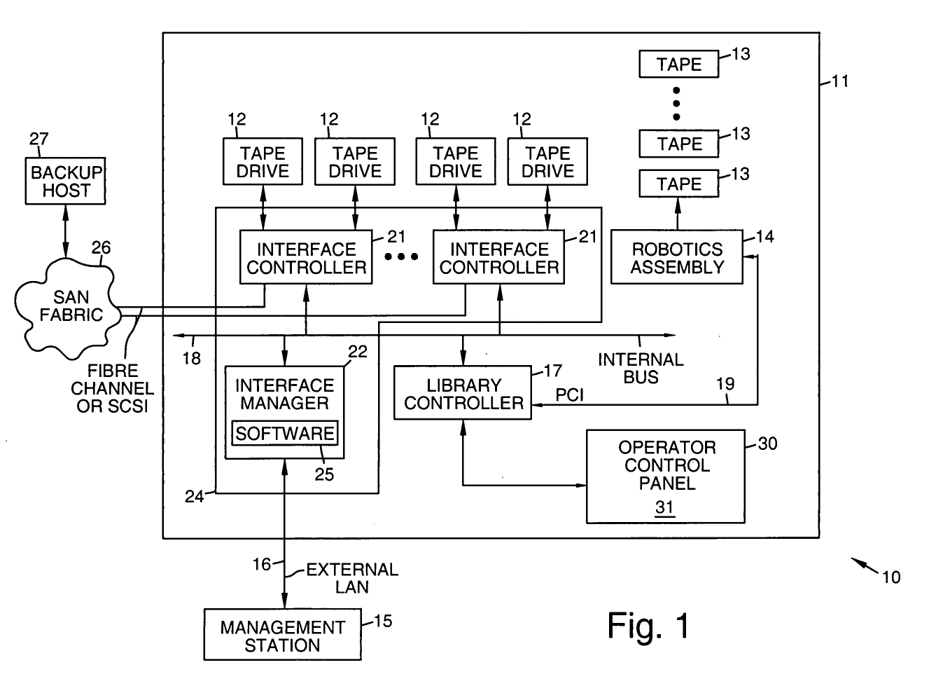

Referring to the drawing figures, FIG. 1 shows exemplary backup storage apparatus 10 comprising an exemplary tape library 10. The exemplary tape library 10 comprises a housing 11 in which a plurality of tape drives 12 (storage devices 12) are housed. A plurality of tape cartridges 13 (storage media 13) are loaded and stored in the housing 11 and which are manipulated by a robotics assembly 14 to load and unload them into a selected tape drive 12 to store data thereon or retrieve data therefrom. In other types of backup storage apparatus 10, the storage device 12 might comprise an optical disk reader used with optical disk media, or removable hard disk drives, for example.

An external management station 15 communicates with the tape library 10 by way of an external local area network (LAN) 16. The management station 15 is coupled by way of the external LAN 16 to a component 22 of the tape library 10 such as an interface manager 22 or management appliance 22. The interface manager 22 or management appliance 22 includes software tools 25 that aid in the configuration, installation, and management of the tape library 10, and specifically allow configuration and control of value added components 24 of the tape library 10. The interface manager 22 is coupled to an internal local area network (LAN) 18 comprising a communication link 18.

One or more interface controllers 21 may be coupled between selected tape drives 12 and the internal LAN 18. The interface controllers 21 provide a communication path for the interface manager 22 to talk to the tape drives 12. The interface controllers 21 also provide a controlled data path between the tape drives 12 and a backup server 26. The backup server 26 communicates with the interface controllers 21 via a Fibre Channel fabric 27, shown in FIG. 1 as a storage area network (SAN) fabric 27, for example. A parallel data bus such as a Small Computer System Interface (SCSI) bus may be used in place of the Fibre Channel fabric 27, but this is not commonly used in current-generation computers.

The interface manager 22 or management appliance 22 and the interface controllers 21 comprise the value added components 24 of the tape library 10, i.e., components that may not be manufactured and installed by the original library manufacturer.

A library controller 17 is coupled by way of the internal LAN 18 (communication link 18) to the one or more interface controllers 21 and to the interface manager 22 or management appliance 22. The library controller 17 is also coupled by the way of a private internal bus such as a PCI bus 19 to the robotics assembly 14.

The tape library 10 comprises an operator control panel and display system 30, referred to as an operator control panel 30 or OCP 30, which is preferably disposed on a front panel of the tape library 10, for ease of use. The operator control panel 30 controls local functions and displays information regarding the health of the tape library 10. The operator control panel 30 presents information about components in the tape library 10 that are built by the original library manufacturer.

The operator control panel 30 comprises a graphical user interface (GUI) 31 that displays library status information and allows a user to access the library menus. These menus allow a user to view or change the library settings, run demonstration programs, and run diagnostic tests, for example.

The operator control panel 30 may be coupled to the library controller 17, and is used to control functions of and display information regarding the tape library 10 in addition to components in the tape library 10 that are installed by the original library manufacturer. In particular the operator control panel 30 may be used to control functions of the interface manager 22 and display information known to it and to the interface controllers.

The communication link 18 and information sharing protocol cooperate to register the library controller 17 with the interface manager 22. Once registered, the interface manager 22 and the library controller 17 communicate over the internal LAN 18 using shared data objects having a shared format (i.e., a format shared by the interface manager 22 and library controller 17). The interface manager 22 and library controller 17 share their respective lists of objects corresponding to services that they provide. In this way, the interface manager 22 discovers services that are provided by the library controller 17 and vice-versa. The library controller 17 uses the shared data objects sent by the interface manager 22 to generate information that is to be displayed on the OCP 30. Furthermore, communication between the interface manager 22 and the library controller 17 via the information sharing protocol and communication link 18 allow the operator control panel 30 to control functions of the interface manager 22 and display information heretofore only available to the interface manager 22.

Heretofore, it has not been possible to easily increase or activate additional capacity or purchase licenses to use the additional capacity when it is needed. Telephone calls to a supplier to increase storage capacity are typically required when using conventional backup storage apparatus or tape libraries. This practice is generally time consuming, and is fraught with potential errors, including providing a wrong serial number or enter a wrong activation key, for example. The backup storage apparatus 10 or tape libraries 10 disclosed herein remedy this problem.

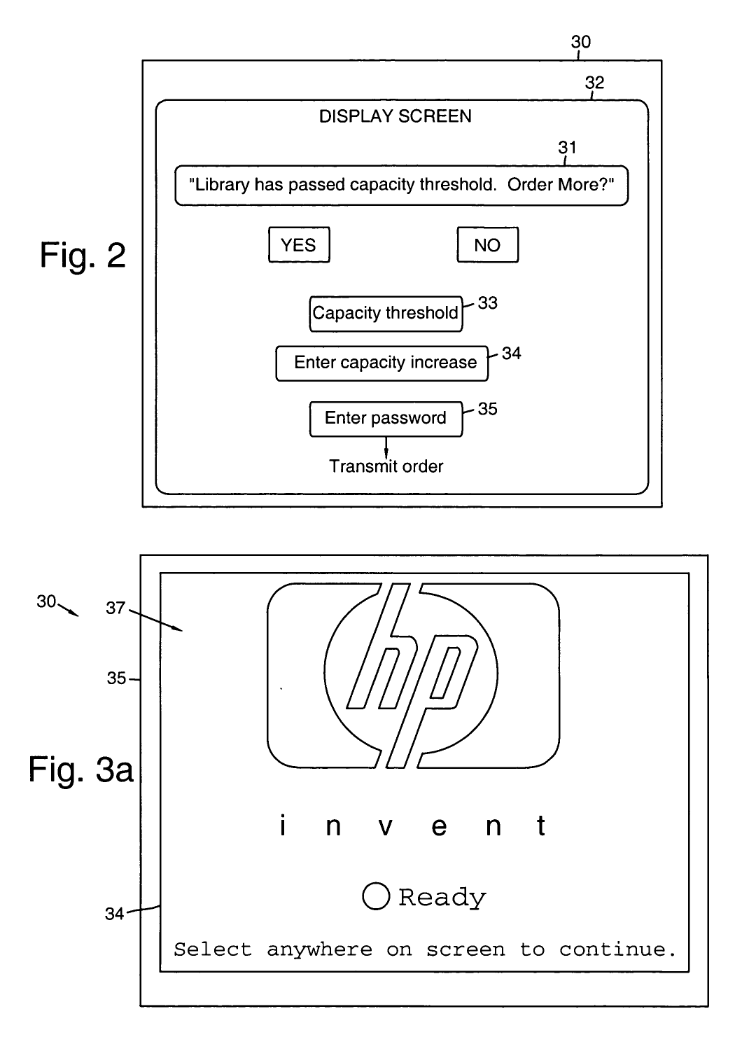

FIG. 2 illustrates exemplary on-demand ordering of storage capacity increases in the backup storage apparatus 10 or tape library 10. The tape library 10 is configured to have an architecture that allows a user (customer) to purchase a base library capacity that includes additional capacity, and then subsequently purchase licenses to use the additional capacity when it is needed.

The architecture provides an infrastructure for sending information to the licensee or manufacturer and receive a license and an activation key from the licensee or manufacturer. The component 22 (interface manager 22) monitors the licensed capacity threshold of the tape library 10. When the tape library 10 nears or reaches its licensed capacity, a prompt 31 is generated by the component 22 (interface manager 22) that is sent to the controller 17, and which is displayed on a display 32 of the operator control panel 30. An exemplary prompt 31 is “Library has passed (is nearing) capacity threshold. Order More?”.

After the prompt 31 is displayed, a user may choose to order additional capacity directly from the available additional, but yet unlicensed, capacity in the tape library 10. After choosing to make the order, such as by selecting a “YES” button or icon, a user configurable capacity threshold 33 is displayed, and the user may select 34 or enter 34 the amount of additional capacity to be purchase. This may be done by typing in the capacity increase amount, or selecting an amount from a pull-down menu, or other similar action, for example. Once the additional capacity to be purchased is entered 34 or selected 34, the user is prompted for a password 35. After the password 35 is entered, a request (order) is transmitted, such as by way of the component 22 (interface manager 22), to the licensee or manufacturer, such as to an appropriate order desk at the licensee or manufacturer, for example. The request (order) is automatically processed at the licensee or manufacturer, such as by automatically logging into a key generation system at the licensee or manufacturer. A license and an activation key are automatically generated and transmitted from the licensee or manufacturer back to the tape library 10 in real time to authorize usage of the additional licensed capacity.

This procedure is completely automatic and only requires signature authorization to expand the capacity of the tape library 10 rather than requiring a complex purchase and setup scheme. This makes it easier to rapidly react to customer requirements and gives customers the ability to provide their backup administrator with authority to expand the capacity of the tape library 10 without having to give them general purchase authority.

This solution requires no verbal interaction with the licensee or manufacturer to increase tape capacity. This solution easily permits a user to increase or activate additional capacity or purchase licenses to use the additional capacity when it is needed.

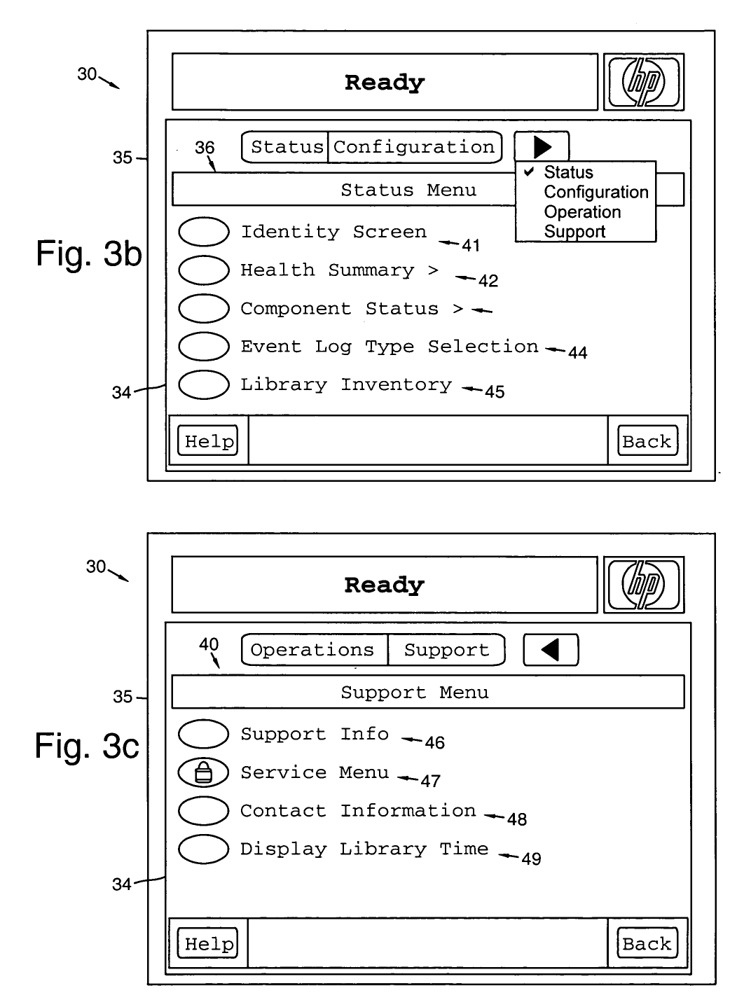

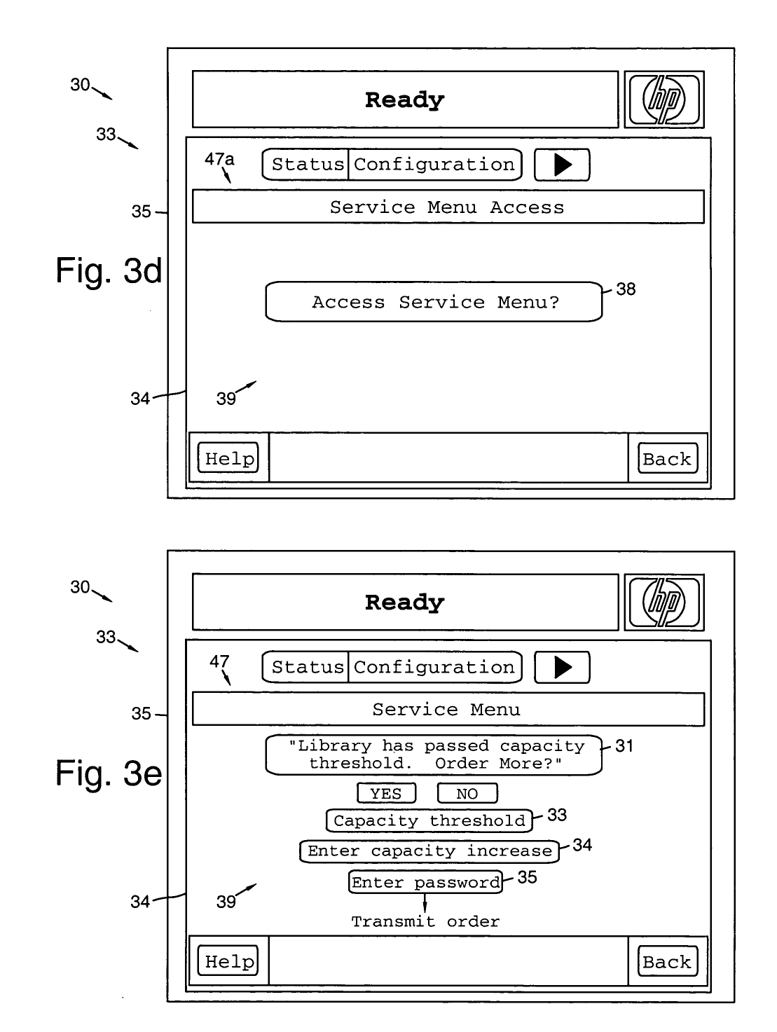

FIGS. 3a-3d illustrate exemplary display screens 34 that may be displayed on exemplary backup storage apparatus 10. FIGS. 3a-3c are exemplary display screens 34 through which a user may migrate in order to order increased storage capacity for the backup storage device 10. FIG. 3d is a display screen 34 that may specifically be used to implement on-demand ordering of storage capacity increases from the backup storage device 10. The operator control panel 30 is configured to provide easy and quick navigation to pertinent menu levels to arrive at a display screen that permits the on-demand ordering of storage capacity increases.

More particularly, FIGS. 3a-3d show exemplary screen displays 34 that may be displayed on the backup storage device 10, such as a tape library 10, for example. Certain of the exemplary screen displays 34 relate to an exemplary on-demand storage capacity ordering function 39 (FIGS. 3b-3d). The exemplary screen displays 34 and on-demand storage capacity ordering function 39 may be presented on a display screen 35 of the operator control panel 30.

The exemplary on-demand storage capacity ordering function 39 may be implemented by way of a support menu 36 that is one menu of a menu structure or tree. The operator control panel 30 has a menu structure that has many paths, such as is illustrated by multiple menus 34 shown in FIGS. 3a-3d, of which the support menu 36 is but one.

FIG. 3a shows an exemplary screen display 34 comprising an initial splash screen 37 showing a logo. A “Ready” button is configured to display green, yellow and red colors, indicating that the library 10 is ready for operation (green), has a minor problem (yellow) or has a major problem *red). Clicking on the screen display 34 takes the user of a subsequent screen display 34, shown in FIG. 3b.

The screen display 34 shown in FIG. 3b may be used to present Status, Configuration, Operation and Support information to the user. The user may display the information contained in the Status, Configuration, Operation and Support menus by clicking on the appropriate button at the top of the screen, or by touching the right pointing arrow to select one of the screens that is not yet displayed (Operation and Support screens, in this case).

The status menu 36 shown in FIG. 3b comprises icons 41-44, selectable text, or a banner, for example, that allows the user to access and display an identity screen 41, a health summary screen 42, a component status screen 43, an event log type selection screen 44, a library inventory screen 45, and other information that is not shown in FIG. 3b. Ellipses at the left side of the display screen 34 shown in FIG. 3b contain no icon, indicating that there are no problems. Status or warning icons may be displayed within the ellipses indicating that errors may be displayed by migrating to the particular screen display 34. Help and Back icons allow a user to access one or more help screens relating to what is displayed on the screen display 34, and to return to the previously displayed screen display 34.

FIG. 3c illustrates an exemplary Support menu 40, which is displayed by clicking on the Support button at the top of the screen shown in FIG. 3b, or by migrating to this screen using the right pointing arrow. The Support menu 40 shown in FIG. 3c allows the user to access support information 46, access a service menu 47 (FIG. 3e), obtain contact information 48, and display library time 49, for example.

Touching the “Service Menu” icon shown in FIG. 3c displays FIG. 3d to the user. FIG. 3d shows a screen display 34 that allows to access the Service menu 47. This screen display 34 is illustrated as a Service Menu Access screen 47a. The Service Menu Access screen 47a presents an Access Service Menu icon 38 that may be touched to migrate to the Service menu 47 shown in FIG. 3e.

The Access Service Menu icon 38 may then be selected to provide on-demand ordering of additional storage capacity. When the Access Service Menu icon 38 is selected, the screen display 34 shown in FIG. 3e is presented. The user is prompted that the “Library has passed capacity threshold. Order More?”, for example. Selecting a YES” button or icon, for example, the user configurable capacity threshold 33 is displayed, and the user may select 34 or enter 34 the amount of additional capacity to be purchase, such as by typing in the capacity increase amount, or selecting an amount from a pull-down menu, or other similar action, for example.

Once the additional capacity to be purchased is entered 34 or selected 34, the user enters a password 35, and a request (order) is transmitted to the licensee or manufacturer. The request (order) is automatically processed at the licensee or manufacturer. A license and an activation key are automatically generated and transmitted from the licensee or manufacturer back to the storage apparatus 10 in real time to authorize usage of the additional licensed capacity.

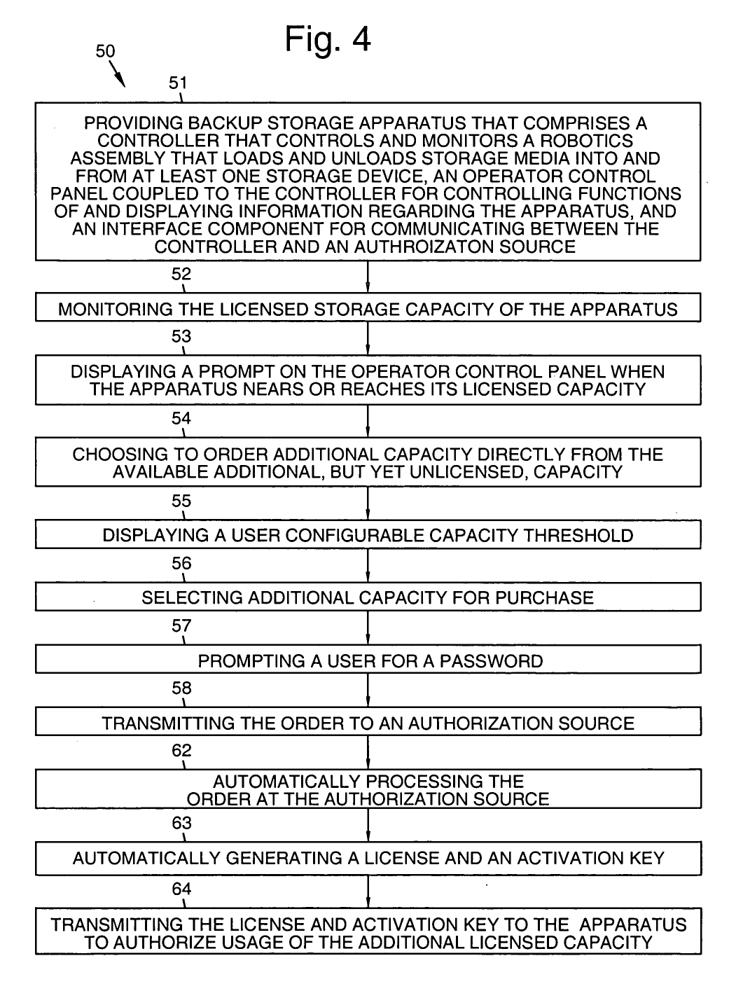

FIG. 4 is a flow diagram that illustrates an exemplary method 50 or algorithm 50 for use in the backup storage apparatus 10. The exemplary method 50 or algorithm 50 may be used with storage apparatus 10 such as magnetic tape libraries, optical drives and hard disk drives, for example, although it is described with reference to use with a tape library 10. The exemplary method 50 or algorithm 50 comprises the following actions.

A tape library 10 (backup storage apparatus 10) is provided 51 that comprises a controller 17 that controls and monitors a robotics assembly 14 that loads and unloads tape cartridges 13 (storage media 13) into and from at least one tape drive 12 (storage device 12), an operator control panel 30 coupled to the controller 17 for controlling functions of and displaying information regarding the tape library 10, and an interface component 22 (interface manager 22) in communication with the controller 17 and that communicates with an authorization source that is authorized to increase the licensed storage capacity of the apparatus 10.

The licensed capacity threshold of the tape library 10 (backup storage apparatus 10) is monitored 52. When the tape library 10 nears or reaches its licensed capacity, a prompt 31 is displayed 53 on a display 32 of the operator control panel 30 indicating same. After the prompt 31 is displayed 53, a user may choose 54 to order additional capacity directly from the available additional, but yet unlicensed, capacity in the tape library 10.

After choosing 54 to make the order, a user configurable capacity threshold 35 is displayed 55. The user selects 56 the amount of additional capacity to be purchase. Once the additional capacity to be purchased is selected 56 or entered 56, the user is optionally prompted to enter 57 a password 35. After the optional password 35 is entered 57, a request (order) is transmitted 58 to an authorization source, such as a licensee or manufacturer.

The request (order) is automatically processed 62 at the authorization source (licensee or manufacturer). A license and an activation key are automatically generated 63 and transmitted 64 from the authorization source (licensee or manufacturer) to the backup storage apparatus in real time to authorize usage of the additional licensed capacity.

Thus, storage apparatus 10 for managing removable media 13 has been disclosed. The controller 17 is configured to robotically manage the removable media 13 and to monitor a licensed storage capacity of the storage apparatus 10. The user interface 31 is coupled to the controller 17 and is operative to display information relating to the storage apparatus 10. When storage capacity reaches a predetermined level of the licensed storage capacity, the user interface 31 displays a prompt to acquire additional licensed storage capacity. The user interface 31 is further operative to display a user configurable capacity threshold, input additional capacity for purchase, allow entry a password, select additional capacity for purchase from available additional, but yet unlicensed, capacity, transmit a request for additional capacity to an authorization source, and receive a license and activation key from the authorization source to authorize usage of the additional licensed capacity.

Thus, backup storage apparatus and related methods that permit on-demand ordering of storage capacity increases have been disclosed. It is to be understood that the above-described embodiments are merely illustrative of some of the many specific embodiments that represent applications of the principles described herein. Clearly, numerous and other arrangements can be readily devised by those skilled in the art without departing from the scope of the invention.

What is claimed is:

1. Storage apparatus for managing removable media, comprising:
a controller configured to robotically manage the removable media and to monitor a licensed storage capacity of the storage apparatus; and
a user interface coupled to the controller;
wherein when storage capacity reaches a predetermined level of the licensed storage capacity, the user interface displays a prompt to acquire additional licensed storage capacity.

2. The apparatus recited in claim 1 wherein the user interface is further operative to:
display a user configurable capacity threshold; and
input additional capacity for purchase.

3. The apparatus recited in claim 1 wherein the user interface is further operative to allow entry a password.

4. The apparatus recited in claim 2 wherein the user interface is further operative to enter a password.

5. The apparatus recited in claim 1 wherein the user interface is further operative to:
select additional capacity for purchase from available additional, but yet unlicensed, capacity;
transmit a request for additional capacity to an authorization source; and
receive a license and activation key from the authorization source to authorize usage of the additional licensed capacity.

6. Apparatus for managing removable media, comprising:
controller means configured to robotically manage the removable media and to monitor a licensed storage capacity of the storage apparatus; and
user interface means coupled to the controller means;
wherein when storage capacity reaches a predetermined level of the licensed storage capacity, the user interface means displays a prompt to acquire additional licensed storage capacity.

7. The apparatus recited in claim 6 wherein the user interface means is further operative to:
display a user configurable capacity threshold; and
input additional capacity for purchase.

8. The apparatus recited in claim 6 wherein the user interface means is further operative to enter a password.

9. The apparatus recited in claim 7 wherein the user interface means is further operative to allow entry a password.

10. The apparatus recited in claim 6 wherein the user interface is further operative to:
select additional capacity for purchase from available additional, but yet unlicensed, capacity;
transmit a request for additional capacity to an authorization source; and
receive a license and activation key from the authorization source to authorize usage of the additional licensed capacity.

11. A method for managing removable media of a storage apparatus, comprising:
configuring a controller to robotically manage removable media and to monitor a licensed storage capacity of the storage apparatus;
coupling a user interface to the controller; and
when the storage capacity reaches a predetermined level of the licensed storage capacity, displaying a prompt via the user interface to acquire additional licensed storage capacity.

12. The method recited in claim 11 wherein selecting additional capacity for purchase comprises:
displaying a user configurable capacity threshold; and
inputting additional capacity for purchase.

13. The method recited in claim 11 further comprising entering a password.

14. The method recited in claim 12 further comprising entering a password.

15. The method recited in claim 11 further comprising:
selecting additional capacity for purchase from available additional, but yet unlicensed, capacity;
transmitting a request for additional capacity to an authorization source;
receiving a license and activation key from the authorization source to authorize usage of the additional licensed capacity.
